(19) United States
(12) Patent Application Publication
(10) Pub. No.: US 2018/0358151 A1
(43) Pub. Date: Dec. 13, 2018

(54) PROTECTIVE MEMBER, PROTECTIVE MEMBER-ATTACHED WIRE, AND PROTECTIVE MEMBER MANUFACTURING METHOD

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Housei MIZUNO, Yokkaichi-shi, Mie (JP); Hiroki HIRAI, Yokkaichi-shi, Mie (JP); Yasuyuki YAMAMOTO, Yokkaichi-shi, Mie (JP); Atsushi MURATA, Yokkaichi-shi, Mie (JP); Yoshitsugu SUSAKI, Sakai-shi, Fukui (JP); Hiroki ICHIURA, Sakai-shi, Fukui (JP); Akihiro NISHIO, Sakai-shi, Fukui (JP)

(21) Appl. No.: 15/775,272

(22) PCT Filed: Nov. 10, 2016
(86) PCT No.: PCT/JP2016/083355

§ 371 Date: May 10, 2018

(30) Foreign Application Priority Data
Nov. 24, 2015 (JP) 2015-228507

(51) Int. Cl. H01B 7/18; H01B 13/14; H01B 7/02; B32B 5/26; B32B 5/02; B32B 5/06; D04H 1/498; D04H 1/54

(52) U.S. Cl. CPC H01B 7/18; H01B 13/14; H01B 7/02; B32B 5/26; B60R 16/0215; B32B 5/06; D04H 1/498; D04H 1/54; B32B 5/022

(57) ABSTRACT

A protective member to be wrapped around an electric wire, in which the protective member has a reduced thickness and exerts, at the same time, both functions of protecting and noise-insulating the electric wire. The protective member is used while being wrapped around the electric wire. The protective member includes: a first sheet material made of a nonwoven fabric; and a second sheet material that is made of a woven fabric, a nonwoven fabric in which fibers longer than fibers of the nonwoven fabric of the first sheet material are joined to each other, or a nonwoven fabric that includes a larger number of joining points at which fibers are intertwined than that of the nonwoven fabric of the first sheet material, the second sheet material being laid on the first sheet material to form one main surface of the protective member.

### CROSS REFERENCE TO RELATED APPLICATIONS

This application claims the priority of Japanese patent application JP2015-228507 filed on Nov. 24, 2015, the entire contents of which are incorporated herein.

### TECHNICAL FIELD

The present invention relates to a protective member to be attached to the circumference of an electric wire.

### BACKGROUND ART

In order to protect an electric wire to be installed in a vehicle or the like, and insulate noise therefrom, for example, a protective member made of a nonwoven fabric may be attached to the circumference of the electric wire. Such a technology is disclosed in, for example, Patent Document 1 (JP2014-67691A) or Patent Document 2 (JP2009-534011A).

In the wire harness disclosed in Patent Document 1, an electric wire is interposed between a sound-proof sheet and a wire protection sheet.

Furthermore, according to the self-wrapping sleeve disclosed in Patent Document 2, noise is reduced as a result of the sleeve made of a nonwoven fabric being wrapped around a wire harness.

### SUMMARY

However, in the wire harness disclosed in Patent Document 1, the sound-proof sheet is provided only on one side of the electric wire, and thus there is the risk that no noise insulation function can be expected on the side on which no sound-proof sheet is provided. Furthermore, as the self-wrapping sleeve disclosed in Patent Document 2, if one type of sheet material can realize both noise insulation and protection, the sheet material will be so thick that the wire harness may interfere with surrounding members when installing the wire harness to the vehicle.

Therefore, it is an object of the present disclosure to provide a technology for a protective member to be wrapped around an electric wire, in which the protective member has a reduced thickness and exerts, at the same time, both functions of protecting and noise-insulating an electric wire.

In order to solve the above-described problem, a protective member according to a first aspect relates to a protective member that is to be wrapped around an electric wire, and includes: a first sheet material made of a nonwoven fabric; and a second sheet material that is made of a nonwoven fabric that includes a larger number of joining points at which fibers are intertwined than that of the nonwoven fabric of the first sheet material, the second sheet material being laid on the first sheet material to form one main surface of the protective member. In the protective member according to the first aspect, the first sheet material and the second sheet material are mechanically intertwined and joined to each other.

A protective member according to a second aspect relates to a protective member that is to be wrapped around an electric wire, and includes: a first sheet material made of a nonwoven fabric containing a resin that has a higher melting point than that of a low melting point resin used as an adhesive resin; and a second sheet material that is made of a nonwoven fabric in which fibers longer than fibers of the nonwoven fabric of the first sheet material are joined to each other, the second sheet material being laid on the first sheet material to form one main surface of the protective member.

A protective member according to a third aspect relates to the protective member according to the second aspect, wherein the first sheet material and the second sheet material are mechanically intertwined and joined to each other.

A protective member according to a fourth aspect relates to the protective member according to the first or third aspect, wherein the first sheet material and the second sheet material are joined to each other by a needle punching method.

A protective member according to a fifth aspect relates to the protective member according to any one of the first to fourth aspects, wherein the second sheet material is made of a spunbond nonwoven fabric.

A protective member according to a sixth aspect relates to the protective member according to the fifth aspect, wherein the spunbond nonwoven fabric includes at least a portion in which fibers are welded to each other.

A protective member according to a seventh aspect relates to a protective member that is to be wrapped around an electric wire, and includes: a first sheet material made of a nonwoven fabric; and a second sheet material that is made of a nonwoven fabric in which fibers longer than fibers of the nonwoven fabric of the first sheet material are joined to each other, or a nonwoven fabric that includes a larger number of joining points at which fibers are intertwined than that of the nonwoven fabric of the first sheet material, the second sheet material being laid on the first sheet material to form one main surface of the protective member, wherein the second sheet material is made of a spunbond nonwoven fabric, and the spunbond nonwoven fabric includes at least a portion in which fibers are welded to each other.

A protective member-attached wire according to an eighth aspect includes: the protective member according to any one of the first to seventh aspects; and an electric wire around which the protective member is wrapped.

A protective member manufacturing method according to a ninth aspect relates to a method for manufacturing a protective member to be wrapped around an electric wire, the method including the steps of: laying a first sheet material made of a nonwoven fabric on a second sheet material that is made of a nonwoven fabric that includes a larger number of joining points at which fibers are intertwined than that of the nonwoven fabric of the first sheet material; and mechanically intertwining and joining the overlapping first and second sheet materials to each other.

A protective member manufacturing method according to a tenth aspect relates to a method for manufacturing a protective member to be wrapped around an electric wire, the method including the steps of: laying a first sheet material made of a nonwoven fabric containing a resin that has a higher melting point than that of a low melting point resin used as an adhesive resin on a second sheet material that is made of a nonwoven fabric in which fibers longer than fibers of the nonwoven fabric of the first sheet material are joined to each other; and joining the overlapping first and second sheet materials to each other.

According to the first to seventh aspects, the first sheet material made of a nonwoven fabric, and the second sheet material that is made of a nonwoven fabric in which fibers longer than fibers of the nonwoven fabric of the first sheet material are joined to each other, or a nonwoven fabric that includes a larger number of joining points at which fibers are intertwined than that of the nonwoven fabric of the first sheet material are provided, the second sheet material being laid on the first sheet material to form one main surface of the protective member. Accordingly, it is possible to reduce the thickness required for the second sheet material to exert wear-resistance sufficient to protect an electric wire. Therefore, it is possible to realize a protective member that has a reduced thickness and exerts, at the same time, both functions of protecting and noise-insulating the electric wire.

Particularly, according to the first and third aspects, since the first sheet material and the second sheet material are mechanically intertwined and joined to each other, fibers of the first sheet material and fibers of the second sheet material are unlikely to separate from each other.

Particularly, according to the fourth aspect, since the first sheet material and the second sheet material are joined to each other using a needle punching method, it is easy to intertwine fibers of the first sheet material and fibers of the second sheet material.

Particularly, according to the fifth and seventh aspects, since the second sheet material is made of a spunbond nonwoven fabric, the second sheet material includes long fibers that were melted and extruded. Accordingly, it is possible to obtain high wear-resistance despite its thickness.

Particularly, according to the sixth and seventh aspects, since the spunbond nonwoven fabric includes at least a portion in which fibers are welded to each other, it is possible to obtain high wear-resistance despite its thickness.

According to the eighth aspect, since the protective member according to any one of the first to seventh aspects, and an electric wire around which the protective member is wrapped are provided, the thickness of the second sheet material can be reduced, making it possible to realize a protective member that has a reduced thickness and exerts, at the same time, both functions of protecting and noise-insulating the electric wire.

According to the ninth and tenth aspects, since the steps of: laying a first sheet material made of a nonwoven fabric on a second sheet material that is made of a nonwoven fabric in which fibers longer than fibers of the nonwoven fabric of the first sheet material are joined to each other, or a nonwoven fabric that includes a larger number of joining points at which fibers are intertwined than that of the nonwoven fabric of the first sheet material; and joining the overlapping first and second sheet materials to each other are provided, the thickness of the second sheet material can be reduced, making it possible to manufacture a protective member that has a reduced thickness and exerts, at the same time, both functions of protecting and noise-insulating the electric wire.

### BRIEF DESCRIPTION OF DRAWINGS

FIG. 1 is a front view illustrating a protective member according to an embodiment.

FIG. 2 is a schematic cross-sectional view illustrating the protective member according to the embodiment.

FIG. 3 is a plan view illustrating a second sheet material.

FIG. 4 is a diagram illustrating an example of a method for manufacturing the second sheet material.

FIG. 5 is a diagram illustrating an example of a method for joining a first sheet material and the second sheet material.

FIG. 6 is a perspective view illustrating a protective member-attached wire.

FIG. 7 is a front view illustrating the protective member-attached wire.

FIG. 8 is a plan view illustrating the protective member-attached wire.

FIG. 9 is a plan view illustrating a modification of the second sheet material.

FIG. 10 is a diagram schematically illustrating a cross section of a protective member according to a modification.

### DESCRIPTION OF EMBODIMENT

### Embodiment

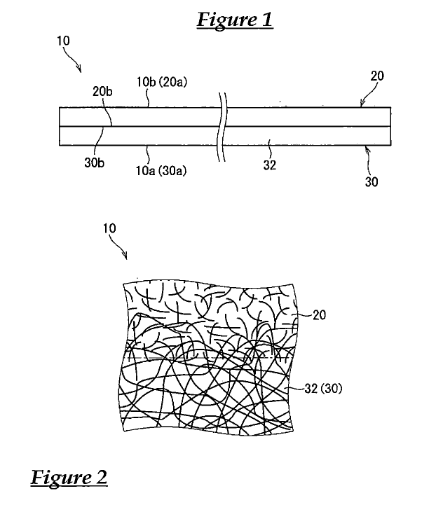

Hereinafter, a protective member 10 according to an embodiment will be described. FIG. 1 is a front view illustrating the protective member 10 according to the embodiment. FIG. 2 is a schematic cross-sectional view of the protective member 10 according to the embodiment.

The protective member 10 is sheet-shaped, and is to be wrapped around an electric wire 80. The protective member 10 is used to protect the electric wire 80 and insulate noise therefrom. Specifically, the protective member 10 includes a first sheet material 20 and a second sheet material 30. The first sheet material 20 and the second sheet material 30 are joined while overlapping each other in a direction orthogonal to their main surfaces. Here, the first sheet material 20 and the second sheet material 30 are joined while directly overlapping each other such that their main surfaces are in contact with each other. More specifically, as a result of the first sheet material 20 and the second sheet material 30 being joined while overlapping each other in the direction orthogonal to the main surfaces, one main surface 30a of the second sheet material 30 serves as one main surface 10a of the protective member 10. Also, here, one main surface 20a of the first sheet material 20 serves as another main surface 10b of the protective member 10. The first sheet material 20 and the second sheet material 30 are joined while overlapping each other such that another main surface 20b of the first sheet material 20 and another main surface 30b of the second sheet material 30 are in contact with each other, resulting in a single protective member 10.

The first sheet material 20 is a portion of the protective member 10 that mainly realizes noise insulation. The first sheet material 20 is made of a nonwoven fabric. As described above, the first sheet material 20, more specifically, the one main surface 20a of the first sheet material 20 serves as the other main surface 10b of the protective member 10. A so-called short-fiber nonwoven fabric made using a dry method or a wet method may be used as the nonwoven fabric of which the first sheet material 20 is made.

Note that it is not essential that the first sheet material 20 serves as the other main surface 10b of the protective member 10. For example, a third sheet material may also be attached to the outer side of the first sheet material 20, and may serve as the other main surface of the protective member.

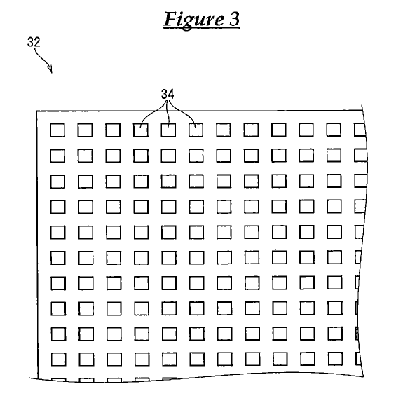

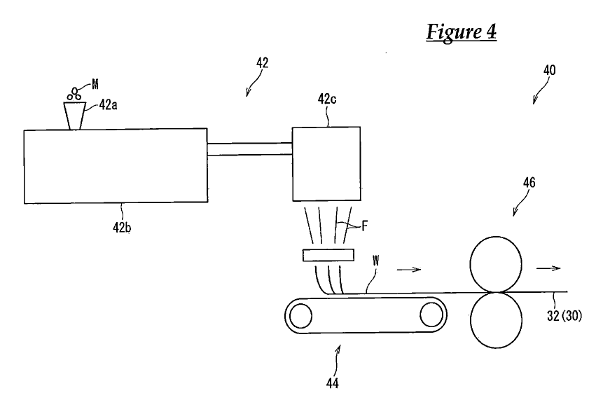

The second sheet material 30 will be described with reference to FIG. 3 in addition to FIGS. 1 and 2. FIG. 3 is a plan view illustrating the second sheet material 30.

The second sheet material 30 is a portion of the protective member 10 that mainly prevents wearing. The second sheet material 30 is made of a nonwoven fabric in which fibers longer than fibers of the nonwoven fabric of the first sheet material 20 are joined to each other. As described above, the second sheet material 30 is laid on the first sheet material 20. Then, the second sheet material 30, more specifically, the one main surface 30a of the second sheet material 30 serves as the one main surface 10a of the protective member 10.

The second sheet material 30 is made of, for example, a spunbond nonwoven fabric 32. “Spunbond nonwoven fabric 32” refers to a nonwoven fabric made through spunbonding. Here, the spunbond nonwoven fabric 32 is such that some fibers are thermally welded to each other. Here, some fibers are thermally welded to each other by subjecting the surface of the spunbond nonwoven fabric 32 to hot embossing.

The nonwoven fabric manufacturing steps are broadly classified into two steps. One is a web forming step of forming a stack of fibers (referred to as a “web”). The other one is a web joining step of joining fibers of the formed web to each other. “Spunbonding” is one method that is used in the web forming step. In the spunbonding, a web is formed by melting a thermoplastic polymer (such as, for example, polypropylene) that serves as a raw material, and discharging it in the shape of continuous long-fibers.

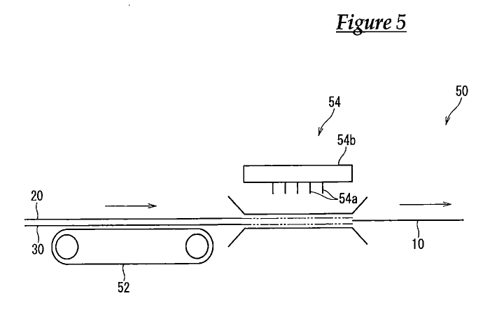

The method for manufacturing the second sheet material 30 will be described taking, as an example, a method in which a sheet material manufacturing device 40, as shown in FIG. 4, is used to manufacture the second sheet material 30. FIG. 4 is a diagram illustrating an example of the method for manufacturing the second sheet material 30.

Here, a configuration of the sheet material manufacturing device 40 will be described first.

The sheet material manufacturing device 40 is provided with a web forming mechanism, a web receiving and conveying mechanism, and a web joining mechanism.

The web forming mechanism is a portion that is used in the web forming step. Here, an extruder 42 is used as the web forming mechanism so as to support spunbonding. The extruder 42 is provided so as to be able to heat and melt an input raw material, and extrude the melted raw material in the form of continuous fibers. The extruder 42 is provided, for example, with: an input portion 42a into which a raw material can be input; an extruding unit 42b for heating and melting the input raw material and extruding the heated and melted raw material; and a discharge unit 42c for spinning the raw material extruded by the extruding unit 42b into a fibrous form and discharging it.

The web receiving and conveying mechanism is a portion for receiving the web formed by the web forming mechanism and conveying the received web to the web joining mechanism. Here, a belt conveyor 44 is used as the web receiving and conveying mechanism. The belt conveyor 44 is provided so as to be able to receive, on its main surface, the web formed by the extruder 42, and convey the received web to the web joining mechanism. The main surface of the belt conveyor 44 on which the web formed by the extruder 42 is received is net like, for example.

The web joining mechanism is a portion that is used in the web joining step. Here, the web joining step employs a thermal joining method, more specifically, a thermal calender method. Accordingly, here, a pair of rollers 46 are used as the web joining mechanism. The pair of rollers 46 sandwiches the web conveyed by the belt conveyor 44 in a state in which the web is heated, that is, the pair of rollers 46 perform thermal pressure-bonding to thermally join fibers of the web to each other.

At this time, when at least one of the pair of rollers 46 is set as an embossing roller, it is possible to emboss the spunbond nonwoven fabric 32. Specifically, a roller 46 whose surface has recesses and projections is used. Here, the recess-and-projection shape of the surface of the roller 46 conforms to embossing to be applied to the spunbond nonwoven fabric 32. More specifically, the recess-and-projection shape of the surface of the roller 46 is inverted with respect to recesses and projections to be formed on the spunbond nonwoven fabric 32.

Note that, in the example shown in FIG. 3, the spunbond nonwoven fabric 32 has an embossed design in which square recesses 34 are lined up at a constant pitch in a width direction and a longitudinal direction, but this is not essential. For example, the recesses may have another polygonal shape such as a triangular shape, or may have a circular shape. Furthermore, for example, the recesses may also be lined up irregularly. The embossed design may be set as appropriate.

Note that it is also conceivable that a winding mechanism is provided on the downstream side of the web joining mechanism, and sequentially wind up manufactured sheet materials.

The following will describe an example of how a sheet material is manufactured using the sheet material manufacturing device 40.

That is, first, a raw material M is input into the input portion 42a of the extruder 42. Then, the input raw material M is heated and melted by the extruding unit 42b, and is extruded to the discharge unit 42c. Then, the melted raw material M is eluted and spun, and is discharged directly from the distal opening of the discharge unit 42c. A plurality of eluted and spun endless long-fibers F are laid on each other on the belt conveyor 44 to form a web W.

Note that a cooling unit for cooling the eluted and spun fibers F, a stretching unit or the like for stretching the eluted and spun fibers F, and the like may also be provided between the discharge unit 42c and the belt conveyor 44.

Then, the formed web W is conveyed by the belt conveyor 44 to the pair of rollers 46. Then, the web W is thermally welded while being sandwiched between the heated pair of rollers 46. When fibers of the web W are thermally joined to each other, a low melting point adhesive resin, called a “binder”, may also be mixed into the raw material.

When the web W is sandwiched between the pair of rollers 46, it is possible to perform embossing at the same time as joining fibers of the web W, since at least one roller 46 is set as an embossing roller. In other words, some fibers can be thermally welded together.

Note that it is not essential to perform thermal pressure-bonding and embossing at the same time using the pair of rollers 46. It is also possible that a pair of rollers for use in thermal pressure-bonding, and a pair of rollers for use in embossing are provided separately.

Then, when fibers of the web W are joined to each other, the spunbond nonwoven fabric 32, that is, the second sheet material 30 is complete. The complete sheet material 30 is wound up by the winding mechanism, for example.

When the spunbond nonwoven fabric 32 is used as the second sheet material 30, the second sheet material 30 can have long fibers. Particularly, endless continuous fibers can be achieved that are continuous, as long as the elution continues. Accordingly, the second sheet material 30 can be expected to have high strength and dimension stability. Also, the strength can be improved since, here, fibers of the web are joined to each other through thermal pressure-bonding. Furthermore, easy manufacturing is possible since the fibers are directly spun, and welded by thermal rollers.

The second sheet material 30 thus manufactured is joined to the first sheet material 20 to form a single protective member 10. Here, as shown in FIG. 2, fibers of the first sheet material 20 and fibers of the second sheet material 30 are mechanically intertwined and joined to each other. At this time, the first sheet material 20 and the second sheet material 30 are joined to each other so that an embossed surface of the second sheet material 30 is located on the outer side.

The following will describe a method for joining the first sheet material 20 and the second sheet material 30 taking, as an example, a method in which a sheet material joining device 50, as shown in FIG. 5, is used to join the first sheet material 20 and the second sheet material 30. FIG. 5 is a diagram illustrating an example of the method for joining the first sheet material 20 and the second sheet material 30.

Here, a configuration of the sheet material joining device 50 will be described first.

The sheet material joining device 50 is provided with a conveying mechanism 52 and a joining mechanism 54.

The conveying mechanism 52 is configured to convey the first sheet material 20 and the second sheet material 30 in a state in which they overlap each other. For example, it is conceivable that the conveying mechanism 52 conveys the rolled first sheet material 20 and the rolled second sheet material 30 separately, and joins them together.

The joining mechanism 54 joins, here, the first sheet material 20 and the second sheet material 30 using a needle punching method. Here, “needle punching method” refers to a method in which, as shown in FIG. 5, a needle 54a with a barb is punched through to mechanically intertwine and join fibers. Specifically, here, the joining mechanism 54 is provided with a plurality of needles 54a each having a barb at the front end, and a driving unit 54b for reciprocating the plurality of needle 54a.

The following will describe an example of how the first sheet material 20 and the second sheet material 30 are joined to each other using the sheet material joining device 50.

That is, first, the conveying mechanism 52 conveys, to the joining mechanism 54, the first sheet material 20 and the second sheet material 30 in a state in which they overlap each other.

The joining mechanism 54 reciprocates, using the driving unit 54b, the needles 54a with respect to the first sheet material 20 and the second sheet material 30 that are being conveyed while overlapping each other, so as to repeatedly perform operations of punching and then pulling out the needles 54a with a barb. Accordingly, when the needles 54a punched into the first sheet material 20 and the second sheet material 30 are pulled out, fibers of one of the sheet materials (for example, the second sheet material 30) that is located on the front end side of the needles 54a are caught on the barbs. Then, the caught fibers are drawn to positions of the other sheet material (for example, the first sheet material 20) as the needles 54a are moved to the side on which they are pulled out. Accordingly, the fibers of both of the sheet materials 20 and 30 are intertwined so that the fibers of the first sheet material 20 and second sheet material 30 are mechanically joined to each other.

When the first sheet material 20 and the second sheet material 30 are mechanically joined to each other in this way, fibers are unlikely to separate from each other. At this time, a needle punching method is used to enable fibers of the first sheet material 20 and fibers of the second sheet material 30 to easily be mechanically joined to each other.

However, it is not essential that the first sheet material 20 and the second sheet material 30 are mechanically joined to each other. For example, the first sheet material 20 and the second sheet material 30 may also be joined to each other using a chemical means such as a chemical bonding method or a thermal means such as a thermal bonding method. Furthermore, even if the first sheet material 20 and the second sheet material 30 are mechanically joined to each other, it is not essential that they are joined to each other using a needle punching method. For example, the first sheet material 20 and the second sheet material 30 may also be joined to each other using another mechanical means such as a spunlace method.

Note that the thickness of the first sheet material 20 is set as appropriate depending on the required level of noise insulation. Furthermore, the thickness of the second sheet material 30 is set as appropriate depending on the required level of wear resistance.

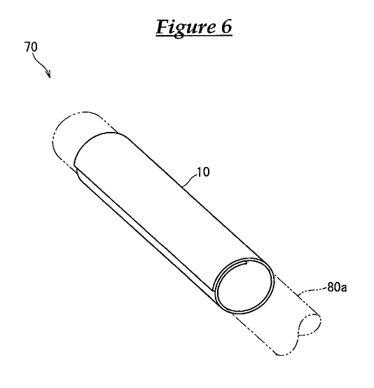

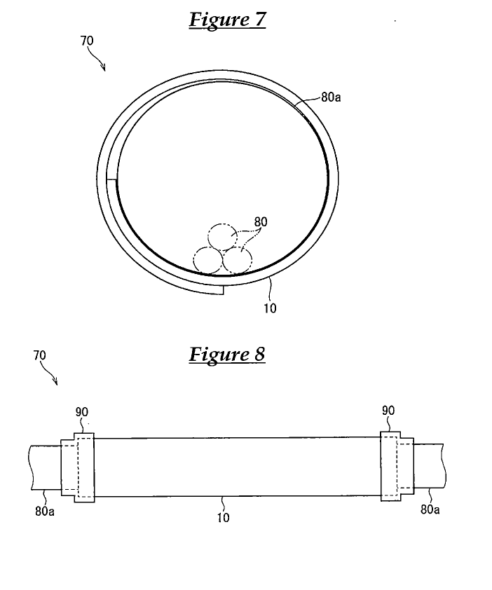

The following will describe a protective member-attached wire 70. FIG. 6 is a perspective view illustrating the protective member-attached wire 70. FIG. 7 is a front view illustrating the protective member-attached wire 70. FIG. 8 is a plan view illustrating the protective member-attached wire 70.

The protective member-attached wire 70 includes the above-described protective member 10, and an electric wire 80 around which the protective member 10 is wrapped.

It is sufficient that at least one electric wire 80 is included. The protective member 10 is externally fitted onto the electric wire 80 at an intermediate portion in the longitudinal direction thereof. The electric wire 80 is configured to have a covered portion obtained by extruding a resin over the outer circumference of a core wire so that the resin covers the core wire, for example. Here, a description is given taking, as an example, an electric wire bundle 80a in which a plurality of electric wires 80 are bundled together. Note that the electric wire bundle 80a may be provided with a light fiber or the like extending along the electric wires 80. The electric wires 80 are arranged at arrangement target locations in a vehicle or the like and are used to electrically connect various types of electrical equipment installed in the vehicle or the like. Note that FIGS. 6 to 8 show a schematic shape of the electric wire bundle 80a.

As described above, here, the protective member 10 is wrapped around the electric wire bundle 80a so that the second sheet material 30 is located on the inner side and the first sheet material 20 is located on the outer side. In this case, the embossed surface of the second sheet material 30 is located on the electric wire bundle 80a side.

Note that, preferably, binding members such as tape 90 can be wound around the protective member 10 so as to maintain, after the protective member 10 has been wrapped around the electric wire bundle 80a, the state in which the protective member 10 is wrapped. At this time, it is more preferable that the tape 90 is wound spanning an end, in the longitudinal direction, of the protective member 10 and the electric wire bundle 80a so that the protective member 10 is positioned with respect to the electric wire bundle 80a. At this time, a piece of tape 90 or the like may also be wound at an intermediate portion, in the longitudinal direction, of the protective member 10. Accordingly, the protective member 10 is more reliably prevented from becoming loose.

According to the embodiment, the protective member 10 includes: the first sheet material 20, which is made of a nonwoven fabric; and the second sheet material 30, which is made of a nonwoven fabric in which fibers longer than the fibers of the above-described nonwoven fabric are joined to each other, the second sheet material 30 being laid on the first sheet material 20 to form one main surface of the protective member 10. It is thus possible to reduce the thickness required for the second sheet material 30 to exert wear-resistance sufficient to protect the electric wire 80. Accordingly, it is possible to achieve the protective member 10 that has a reduced thickness and, at the same time, exerts both functions to protect the electric wire 80 and insulate noise therefrom.

Furthermore, since the first sheet material 20 and the second sheet material 30 are mechanically intertwined and joined to each other, fibers of the first sheet material 20 and fibers of the second sheet material 30 are unlikely to separate from each other.

Furthermore, since the first sheet material 20 and the second sheet material 30 are joined to each other by a needle punching method, it is possible to easily intertwine fibers of the first sheet material 20 and fibers of the second sheet material 30.

Furthermore, since the second sheet material 30 is made of the spunbond nonwoven fabric 32, the second sheet material 30 includes long fibers that were melted and extruded. Accordingly, it is possible to obtain high wear-resistance despite its thickness. Furthermore, a higher wear-resistance ability can be obtained, since, here, long fibers are joined to each other by thermal pressure bonding.

Moreover, since the spunbond nonwoven fabric 32 is such that some fibers are thermally welded to each other, a higher wear-resistance ability can be obtained despite its thickness.

Furthermore, since the spunbond nonwoven fabric 32 has an embossed surface, and the embossed surface comes into contact with the electric wires 80, the area that is in contact with the electric wires 80 is reduced. Accordingly, a higher wear-resistance ability can be obtained despite its thickness.

### MODIFICATIONS

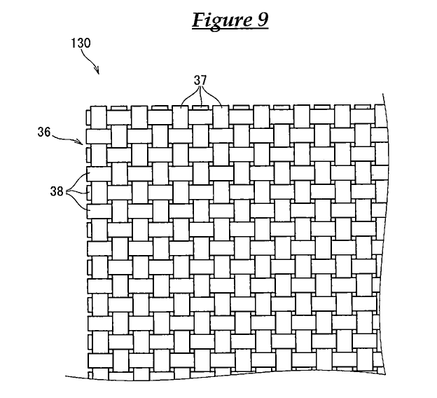

In the embodiment, a description has been given assuming that the second sheet material 30 is made of a nonwoven fabric with long fibers as the spunbond nonwoven fabric 32, but this is not essential. For example, the second sheet material may also be made of a woven fabric 36 as shown in FIG. 9.

The woven fabric 36 is made by weaving warps 37 and wefts 38. It is conceivable that the warps 37 and the wefts 38 are made of resin, for example. Although, in the example shown in FIG. 9, the warps 37 and the wefts 38 of the woven fabric 36 are set to have the same thickness, but the warps 37 and the wefts 38 may also be set to have different thicknesses.

Also by using a second sheet material 130 made of such a woven fabric 36, it is possible to reduce the thickness required for the second sheet material 130 to exert wear-resistance sufficient to protect the electric wire 80. Accordingly, it is possible to realize the protective member that has a reduced thickness and exerts, at the same time, both functions of protecting and noise-insulating the electric wire 80.

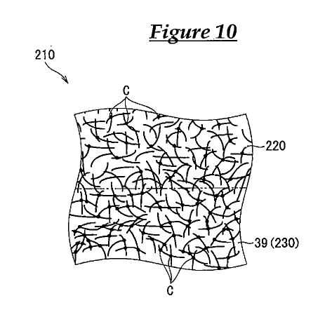

Furthermore, the second sheet material may also be made of, for example, a nonwoven fabric 39 as shown in FIG. 10. FIG. 10 is a diagram schematically illustrating a cross section of a protective member 210 according to a modification. Note that FIG. 10 shows joining points C at which fibers are joined to each other while placing an emphasis thereon.

The nonwoven fabric 39 is formed so as to include a larger number of joining points C at which fibers are intertwined than in a nonwoven fabric of a first sheet material 220. Accordingly, a second sheet material 230 made of this nonwoven fabric 39 has wear-resistance superior to that of the first sheet material 220. Note that the fibers of the nonwoven fabric 39 are not necessarily as long as those of the spunbond nonwoven fabric 32, and may be set as appropriate.

Such a nonwoven fabric 39 can be formed by using, for example, a larger amount of adhesive to be attached to webs when the webs are joined to each other through a chemical bonding method, or a larger amount of fibers made of a low melting point resin that are to be mixed into fibers of webs when the webs are joined to each other through a thermal bonding method, than when the nonwoven fabric of the first sheet material 220 is formed. Here, the low melting point resin may be a resin that has a lower melting point than that of a resin of which the webs are made. For example, if polyester (PET) whose melting point is about 230 degree is used as the resin of which the webs are made, low melting point polyester (L-PET) that has a melting point (for example, about 120 degree) lower than that of the PET may be used as the low melting point resin adhesive resin. Note that “the resin of which the webs are made” and “low melting point resin” may be present separately in a state prior to being joined to each other, or may be present as a composite fiber of the core-in-sheath type.

Note that the number of joining points C of the nonwoven fabric of the first sheet material 220 and the number of joining points C of the nonwoven fabric 39 of the second sheet material 230 can be compared, for example, by observing part of a cross section of the protective member 210 with a SEM (scanning electron microscope) or the like.

Also with this second sheet material 230 made of the nonwoven fabric 39, it is possible to reduce the thickness required for the second sheet material 230 to exert wear-resistance sufficient to protect the electric wire 80. Accordingly, it is possible to realize the protective member 210 that has a reduced thickness and exerts, at the same time, both functions of protecting and noise-insulating the electric wire 80.

Furthermore, even in a case where a nonwoven fabric that includes fibers longer than the fibers of the nonwoven fabric of the first sheet material 20 is used as the second sheet material 30, it is not essential that the second sheet material 30 is the spunbond nonwoven fabric 32. For example, the second sheet material may also be a nonwoven fabric that includes fibers longer than fibers of the nonwoven fabric of the first sheet material 20 formed through a melt-blown method, or the like.

Furthermore, in the embodiment, the first sheet material 20 and the second sheet material 30 are joined to each other while overlapping each other so that they are in direct contact with each other, but this is not essential. The first sheet material 20 and the second sheet material 30 may also overlap each other with another sheet material or the like interposed therebetween, for example. In this case, the first sheet material 20 and the second sheet material 30 may be indirectly joined to each other, as a result of, for example, the first sheet material 20 and the other sheet material being joined to each other with their main surfaces being in contact with each other, and on the side opposite to the first sheet material 20, the other sheet material and the second sheet material 30 being joined to each other with their main surfaces being in contact with each other. Of course, it is also conceivable that the first sheet material 20 and the second sheet material 30 are directly joined to each other by performing needle punching on the first sheet material 20 to the second sheet material 30 via the other sheet material.

Note that configurations described in the above-described embodiment and modifications may be combined with each other as appropriate as long as they are not inconsistent with each other.

The details of the present disclosure have been described above, but the description above is exemplary in all aspects and the present invention is not limited to this. It is to be construed that various modifications that are not shown as examples are possible without departing from the scope of the present invention.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 Protective member
20 First sheet material
30 Second sheet material
32 Spunbond nonwoven fabric
34 Recess
36 Woven fabric
39 Nonwoven fabric
40 Sheet material manufacturing device
50 Sheet material joining device
70 Protective member-attached wire
80 Electric wire
C Joining point

1. A protective member to be wrapped around an electric wire, comprising:
a first sheet material made of a nonwoven fabric; and
a second sheet material that is made of a nonwoven fabric that includes a larger number of joining points at which fibers are intertwined than that of the nonwoven fabric of the first sheet material, the second sheet material being laid on the first sheet material to form one main surface of the protective member,
wherein the first sheet material and the second sheet material are mechanically intertwined and joined to each other.

2. The protective member according to claim 8,
wherein the first sheet material and the second sheet material are mechanically intertwined and joined to each other.

3. The protective member according to claim 1,
wherein the first sheet material and the second sheet material are joined to each other using a needle punching method.

4. The protective member according to claim 1,
wherein the second sheet material is made of a spunbond nonwoven fabric.

5. The protective member according to claim 4,
wherein the spunbond nonwoven fabric includes at least a portion in which fibers are welded to each other.

6. A protective member-attached wire comprising:
the protective member according to claim 1; and
an electric wire around which the protective member is wrapped.

7. A method for manufacturing a protective member to be wrapped around an electric wire, comprising the steps of:
laying a first sheet material made of a nonwoven fabric on a second sheet material that is made of a nonwoven fabric that includes a larger number of joining points at which fibers are intertwined than that of the nonwoven fabric of the first sheet material; and
mechanically intertwining and joining the overlapping first and second sheet materials to each other.

8. A protective member to be wrapped around an electric wire, comprising:
a first sheet material made of a nonwoven fabric containing a resin that has a higher melting point than that of a low melting point resin used as an adhesive resin; and
a second sheet material that is made of a nonwoven fabric in which longer fibers longer than fibers of the nonwoven fabric of the first sheet material are joined to each other, the second sheet material being laid on the first sheet material to form one main surface of the protective member.

9. The protective member according to claim 8,
wherein the second sheet material is made of a spunbond nonwoven fabric.

10. The protective member according to claim 9,
wherein the spunbond nonwoven fabric includes at least a portion in which fibers are welded to each other.

11. A protective member-attached wire comprising:
the protective member according to claim 8; and
an electric wire around which the protective member is wrapped.

12. A protective member to be wrapped around an electric wire, comprising:
a first sheet material made of a nonwoven fabric; and
a second sheet material that is made of a nonwoven fabric in which longer fibers longer than fibers of the nonwoven fabric of the first sheet material are joined to each other, or a nonwoven fabric that includes a larger number of joining points at which fibers are intertwined than that of the nonwoven fabric of the first sheet material, the second sheet material being laid on the first sheet material to form one main surface of the protective member,
wherein the second sheet material is made of a spunbond nonwoven fabric, and the spunbond nonwoven fabric includes at least a portion in which fibers are welded to each other.

13. A protective member-attached wire comprising:
the protective member according to claim 12; and
an electric wire around which the protective member is wrapped.

14. A method for manufacturing a protective member to be wrapped around an electric wire, comprising the steps of:
laying a first sheet material made of a nonwoven fabric containing a resin that has a higher melting point than that of a low melting point resin used as an adhesive resin on a second sheet material that is made of a nonwoven fabric in which longer fibers longer than fibers of the nonwoven fabric of the first sheet material are joined to each other; and
joining the overlapping first and second sheet materials to each other.
